(19) United States
(12) Patent Application Publication
(10) Pub. No.: US 2012/0212092 A1
(43) Pub. Date: Aug. 23, 2012

(54) ROTATING DEVICE HAVING A ROTOR AND A STATOR

(75) Inventors: Hiromitsu GOTO, Fujieda-shi (JP); Kazuyoshi NAGAI, Fujieda-shi (JP)

(73) Assignee: ALPHANA TECHNOLOGY CO., LTD., Fujieda-shi (JP)

(21) Appl. No.: 13/372,213

(22) Filed: Feb. 13, 2012

(30) Foreign Application Priority Data
Feb. 22, 2011 (JP) 2011-036323

(51) Int. Cl. H02K 7/08

(52) U.S. Cl. 310/90

(57) ABSTRACT

The rotating device comprises the rotor to which the magnetic recording disk is to be mounted and a stator rotatably supporting the rotor. The stator includes: a bearing unit rotatably supporting the rotor by generating dynamic pressure in lubricant that intervenes between the rotor and the stator; and a base on which a central hole is formed, the center of the central hole being along the rotational axis of the rotor and the bearing unit being fixed to the central hole. The bearing unit includes the housing and the sleeve. The housing includes: a first outer surface joining the central hole; and a second outer surface formed more radially outward from the rotational axis than the first outer surface, the second outer surface partly overlapping the first outer surface in the axial direction.

### CROSS-REFERENCES TO RELATED APPLICATIONS

This application claims priority from Japanese Application No. 2011-036323, filed on Feb. 22, 2011.

### BACKGROUND OF THE INVENTION

1. Field of the Invention

The present invention relates to a rotating device having a rotor and a stator.

2. Description of the Related Art

Disk drive devices, such as hard disk drives, have become miniaturized. The capacity of a disk drive device has also been increased. Such disk drive devices have been installed in various types of electronic devices. In particular, such disk drive devices have been installed in portable electronic devices such as laptop computers or portable music players. In reference to related art, a disk drive device comprising a fluid dynamic bearing described for example in Japanese Patent Application Publication No. 2010-175046 has been proposed.

Compared with the case of stationary electronic devices such as personal computers, it is required that the impact resistance of disk drive devices that are installed in portable electronic devices be improved so that the disk drive devices can withstand impact, such as that due to dropping.

### SUMMARY OF THE INVENTION

In the case where an impact is applied to a disk drive device having a fluid dynamic bearing, if a base and a bearing unit are joined together with insufficient strength, the bearing unit may move relative to the base due to the application of impact-based stress at the joined portion. In addition, lubricant that is used for the fluid dynamic bearing may scatter due to the impact. The fluid dynamic bearing may malfunction if the amount of the lubricant decreases due to the scatter.

In the disk drive device of the type described in Japanese patent application 2010-175046, a capillary seal portion is located right above the joined portion between the base and the bearing unit. In this structure, if the total thickness of the disk drive device is to be maintained, elongating either of the joined portion or the capillary seal portion requires shortening the other. Therefore, it is challenging to improve both the shock-resistance in relation to the joint strength and the shock-resistance in relation to the scatter of the lubricant.

Such desire to improve shock-resistance may be felt not only for the field of disk drive devices but also for other types of rotating devices.

The present invention addresses these disadvantages, and a general purpose of one embodiment of the present invention is to provide a rotating device that has good impact resistance.

An embodiment of the present invention relates to a rotating device. The rotating device comprises: a rotor on which a recording disk is to be mounted; and a stator rotatably supporting the rotor. The stator includes: a bearing unit rotatably supporting the rotor by generating dynamic pressure in a lubricant that intervenes between the rotor and the stator; and a base on which a central hole is formed, the center of the central hole being along the rotational axis of the rotor and the bearing unit being fixed to the central hole. The bearing unit includes: a first outer surface joining the central hole; and a second outer surface formed more radially outward from the rotational axis than the first outer surface, the second outer surface partly overlapping the first outer surface in the axial direction. A gas-liquid interface of the lubricant exists in a gap between the second outer surface and a facing surface of the rotor that faces the second outer surface.

A further embodiment of the present invention relates to a rotating device. The rotating device comprises: a rotor; and a stator rotatably supporting the rotor. The stator includes: a bearing unit rotatably supporting the rotor by generating dynamic pressure in lubricant that intervenes between the rotor and the stator; and a base on which a central hole is formed, the center of the central hole being along the rotational axis of the rotor and the bearing unit being fixed to the central hole. The base includes a base protruding portion that protrudes axially towards the rotor. The bearing unit includes a bearing protruding portion provided more radially outward from the rotational axis than the base protruding portion, the bearing protruding portion axially protruding towards the base. The bearing unit is mounted to the base so that the base protruding portion overlaps the bearing protruding portion in the axial direction.

Optional combinations of the aforementioned constituting elements and implementations of the invention in the form of methods, apparatuses, or systems may also be practiced as additional modes of the present invention.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1A and FIG. 1B are a top view and a side view, respectively, of a rotating device according to an embodiment;

FIG. 2 is a section view sectioned along the line A-A of FIG. 1A; and

FIG. 3 is an enlarged section view, enlarging a portion of a section of the rotating device shown in FIG. 2.

### DETAILED DESCRIPTION OF THE INVENTION

The invention will now be described by reference to the preferred embodiments. This does not intend to limit the scope of the present invention but to exemplify the invention. The size of the component in each figure may be changed in order to aid understanding. Some of the components in each figure may be omitted if they are not important for explanation.

A rotating device according to an embodiment of the present invention is preferably used as a disk drive device such as a hard disk drive having a magnetic recording disk. In the rotating device according to this embodiment, a gas-liquid interface of lubricant and a central hole of a base into which a bearing unit is inserted are mutually displaced in planar view. This displacement reduces the correlation, in a direction along which the thickness of the rotating device is measured, between a capillary seal and an interface between the bearing unit and the base. As a result, each of the interface and the capillary seal can be more freely elongated. In particular, in the case where the maximum thickness of the rotating device is determined by industry standard, etc., the rotating device according to this embodiment preferably allows the capillary seal to be made longer and at the same time allows the joint strength between the bearing unit and the base to be increased.

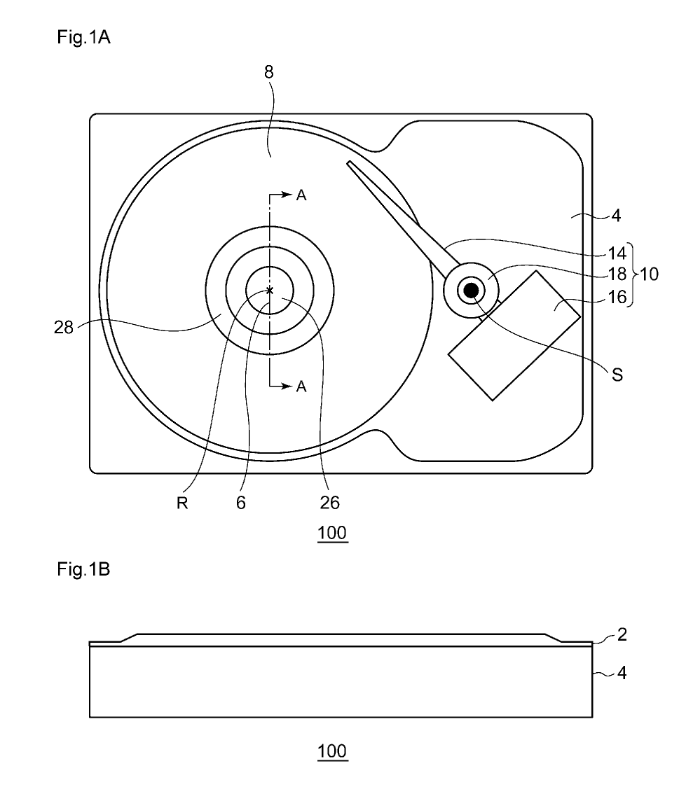

FIG. 1A and FIG. 1B are a top view and a side view of the rotating device 100, respectively, according to an embodiment. FIG. 1A is a top view of the rotating device 100. In FIG. 1A, the rotating device 100 is shown without a top cover 2 in order to show the inside of the rotating device 100. The rotating device 100 comprises: a base 4; a rotor 6; a magnetic recording disk 8; a data read/write unit 10; and the top cover 2. Hereinafter, it is assumed that the side of the base 4 onto which the rotor 6 is installed is the “upper” side.

The magnetic recording disk 8 is mounted on the rotor 6 and rotates with the rotor 6. The rotor 6 is rotatably mounted to the base 4 through the bearing unit 12, which is not shown in FIG. 1A. The base 4 is produced by die-casting an alloy of aluminum.

The data read/write unit 10 includes: a read/write head (not shown); a swing arm 14; a voice coil motor 16; and a pivot assembly 18. The read/write head is attached to the tip of the swing arm 14. The read/write head records data onto and reads out data from the magnetic recording disk 8. The pivot assembly 18 swingably supports the swing arm 14 with respect to the base 4 around the head rotation axis S. The voice coil motor 16 swings the swing arm 14 around the head rotation axis S and moves the read/write head to the desired position on the upper surface of the magnetic recording disk 8. The voice coil motor 16 and the pivot assembly 18 are constructed using a known technique for controlling the position of the head.

FIG. 1B is a side view of the rotating device 100. The top cover 2 is fixed to the base 4 using screws (not shown).

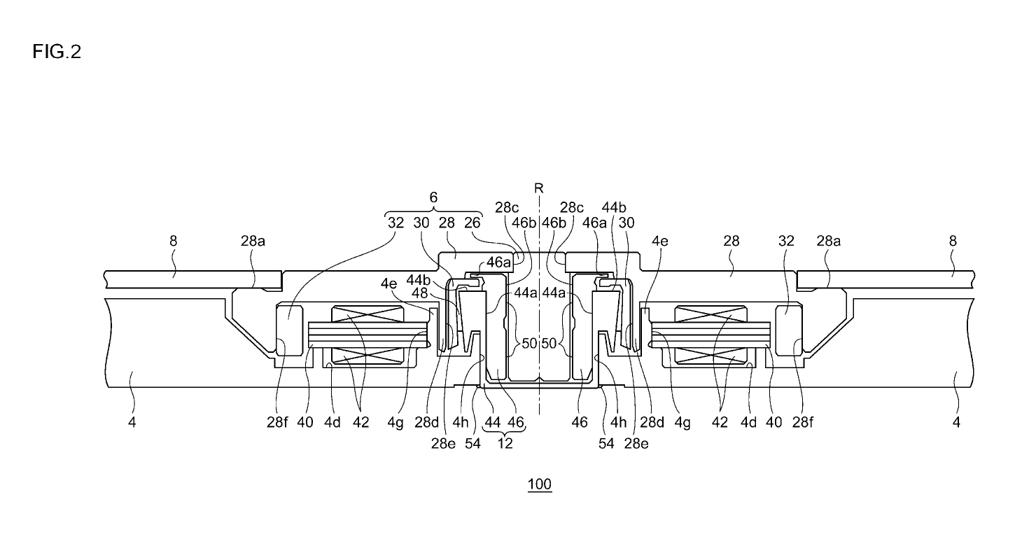

FIG. 2 is a view that is sectioned along the line A-A, as illustrated in FIG. 1A. The rotating device 100 comprises the rotor 6 to which the magnetic recording disk 8 is to be mounted and a stator rotatably supporting the rotor 6. The rotor 6 includes a shaft 26, a hub 28, a flange 30, and a cylindrical magnet 32. The stator includes the base 4, a laminated core 40, coils 42, and the bearing unit 12. The central hole 4h, the center of which being along the rotational axis R of the rotor 6, is formed on the base 4. The central hole 4h penetrates through the base 4. The bearing unit 12 is fixed to the central hole 4h.

The laminated core 40 has a ring portion and twelve teeth, which extend radially (i.e., in a direction perpendicular to the rotational axis R) outward from the ring portion, and the laminated core 40 is fixed on the upper surface 4d side of the base 4. The laminated core 40 is formed by laminating and mechanically integrating four thin magnetic steel sheets. An insulation coating is applied onto the surface of the laminated core 40 by electrodeposition coating or powder coating. Each of the coils 42 is wound around one of the twelve teeth, respectively. A driving flux is generated along the teeth by applying a three-phase sinusoidal driving current through the coils 42. A ring-shaped wall 4e, the center of which being along the rotational axis R of the rotor 6, is formed on the upper surface 4d of the base 4. The laminated core 40 is fitted to the outer surface 4g of the ring-shaped wall 4e with a press-fit or clearance fit and glued thereon.

The bearing unit 12 rotatably supports the rotor 6 with respect to the stator by generating dynamic pressure in a lubricant 48 that intervenes between the rotor 6 and the stator. The bearing unit 12 includes the housing 44 and the sleeve 46. The housing 44 is formed to be cup-shaped and is glued in the central hole 4h of the base 4 by glue 54. The sleeve 46 is formed separately from the housing 44. The sleeve 46 is glued onto the inner surface 44a of the housing 44. The sleeve 46 surrounds the shaft 26, forming a gap. A jetty portion 46a, which juts radially outward, is formed at the upper end of the sleeve 46. This jetty portion 46a, in cooperation with the flange 30, limits the motion of the rotor 6 in the direction along the rotational axis R.

The magnetic recording disk 8 is mounted on a disk-mount surface 28a of the hub 28 using a clamper (not shown). The hub 28 is made of soft-magnetic steel such as SUS430F. The hub 28 is formed to be predetermined cup-like shape by, for example, the press working or cutting of a steel plate. For example, the hub 28 may preferably be made of the stainless steel (DHS1) provided by Daido Steel Co., Ltd., since the stainless steel has lower outgas and is easily-worked. The hub 28 may more preferably be made of the stainless steel (DHS2) provided by Daido Steel Co., Ltd., since the stainless steel has high corrosion resistance. The hub 28 includes a hub protruding portion 28d that protrudes towards the base 4 in the axial direction (in the direction along the rotational axis R). In a region that is more radially inward to the rotational axis R than the ring-shaped wall 4e, the hub protruding portion 28d surrounds the bearing unit 12.

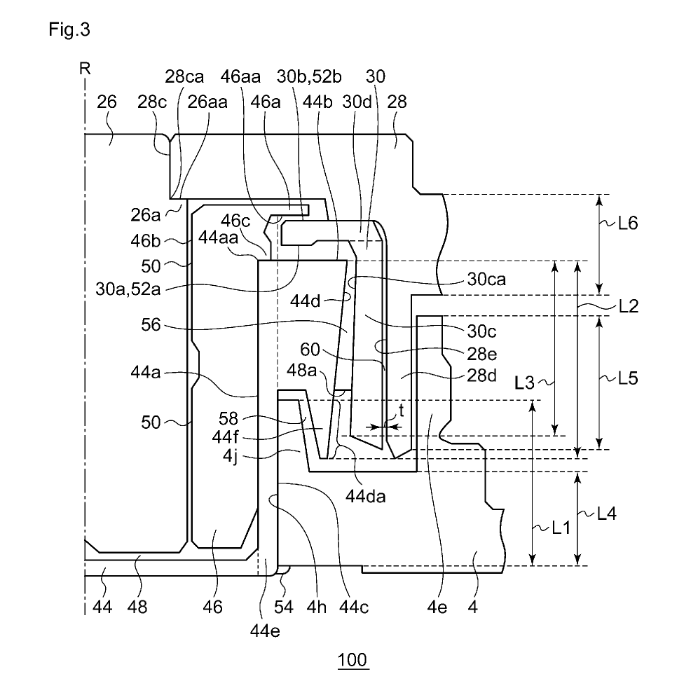

The upper end of the shaft 26 is inserted into the hole 28c arranged at the center of the hub 28, the hole 28c being arranged coaxially with the rotational axis R of the rotor 6. The flange 30 is formed by cutting or press working of metal such as stainless steel. The flange 30 is formed separately from the hub 28 and is in a ring-shape with the center at the rotational axis R. The flange 30 has a reverse L-shaped cross section. The flange 30 is glued onto an inner surface 28e of the hub protruding portion 28d of the hub 28. In other words, a glue layer 60 (with reference to FIG. 3) made of glue intervenes between the flange 30 and the hub protruding portion 28d.

The cylindrical magnet 32 is glued onto a cylindrical inner surface 28f, which is an inner cylindrical surface of the hub 28. The cylindrical magnet 32 is made of a rare-earth material such as Neodymium, Iron, or Boron. The cylindrical magnet 32 faces radially towards the twelve teeth of the laminated core 40. The cylindrical magnet 32 is magnetized for driving, with sixteen poles along the circumferential direction (i.e., in a tangential direction of a circle, the center of which being in the rotational axis R). The surface of the cylindrical magnet 32 is treated by electro deposition coating or spray coating so as to prevent rusting.

FIG. 3 is an enlarged section view that enlarges a portion of a section of the rotating device 100 shown in FIG. 2. The lubricant 48 is injected into a gap between the rotor 6 and the stator. In particular, the lubricant 48 is injected into the region in between part of the rotor 6 (the shaft 26, the flange 30, and the hub 28) and the bearing unit 12.

A pair of herringbone-shaped radial dynamic pressure generation grooves 50, which are vertically separated from each other, are formed on the inner surface 46b of the sleeve 46. A first set of herringbone-shaped thrust dynamic pressure generation grooves 52a is formed on a lower facing surface 30a of the flange 30, which faces the upper surface 44b of the housing 44. A second set of herringbone-shaped thrust dynamic pressure generation grooves 52b is formed on the upper facing surface 30b of the flange 30, which faces the lower surface 46aa of the jetty portion 46a. When the rotor 6 rotates, the rotor 6 is axially and radially supported by the dynamic pressure generated in the lubricant 48 by these sets of dynamic pressure generation grooves.

The two sets of herringbone-shaped radial dynamic pressure generation grooves may be formed on the shaft 26. The first set of thrust dynamic pressure generation grooves can be formed on the upper surface 44b of the housing 44, and the second set of thrust dynamic pressure generation grooves may be formed on the lower surface 46aa of the jetty portion 46a.

The housing 44 has a first outer surface 44c of cylindrical shape and a second outer surface 44d, which is formed more radially outward from the rotational axis R than the first outer surface 44c. The first outer surface 44c is glued to the central hole 4h of the base 4. The second outer surface 44d is substantially a part of a conical surface of a cone, which points downward. An overlapping portion 44da, which is a lower part of the second outer surface 44d, overlaps the first outer surface 44c in the axial direction. That is, when viewed from the radial direction, the overlapping portion 44da overlaps the first outer surface 44c. In other words, when a coordinate is defined by defining the rotational axis R as an axis of the coordinate, a range of coordinates in which the overlapping portion 44da exists overlaps a range of coordinates in which the first outer surface 44c exists. Still, in other words, the overlapping portion 44da of the second outer surface 44d surrounds the first outer surface 44c.

The flange 30 has a disk-like portion 30d, the center of which being along the rotational axis R, and a ring portion 30c that surrounds the bearing unit 12 along the axial direction, the ring portion 30c being coupled to a radially outward portion of the disk-like portion 30d or to one end of the disk-like portion 30d that is farther from the rotational axis R. The whole disk-like portion 30d is located in a region that is more radially outward from the rotational axis R than the first outer surface 44c of the housing 44. A radially inward portion of the disk-like portion 30d or the other end of the disk-like portion 30d that is closer to the rotational axis R has the lower facing surface 30a and the upper facing surface 30b.

A gas-liquid interface 48a of the lubricant 48 exists in a gap 56 between the inner surface 30ca of the ring portion 30c and the second outer surface 44d of the housing 44. In particular, the gap 56 forms a capillary seal, where the gap 56 gradually increases downward. The capillary seal functions as a reservoir for the lubricant 48 and prevents leakage of the lubricant 48 by way of the capillary effect. In this embodiment, a full-fill structure is adopted in which only a single gas-liquid interface 48a is provided.

The housing 44 has a cylindrical portion 44e having the first outer surface 44c and a bearing protruding portion 44f protruding downward in the axial direction, the bearing protruding portion 44f having the overlapping portion 44da of the second outer surface 44d of the housing 44. A bearing concave portion 58 is formed between the cylindrical portion 44e and the bearing protruding portion 44f. The bearing concave portion 58 is an upward recess and is ring-shaped with its center along the rotational axis R. The base 4 includes a base protruding portion 4j protruding upward in the axial direction, the base protruding portion 4j being ring-shaped with its center along the rotational axis R. An inner surface of the base protruding portion 4j forms a part of the inner surface of the central hole 4h. The base protruding portion 4j enters the bearing concave portion 58.

Therefore, the base protruding portion 4j is provided more radially inward to the rotational axis R than the bearing protruding portion 44f. The base protruding portion 4j is at least partially surrounded by the bearing protruding portion 44f or the second outer surface 44d. The bearing unit 12 is mounted to the base 4 so that the base protruding portion 4j at least partially overlaps the bearing protruding portion 44f in the axial direction.

In this embodiment, the housing 44 is formed so that the length L1, in the axial direction, of a part of the first outer surface 44c that faces the inner surface of the central hole 4h is less than the length L2, in the axial direction, of the second outer surface 44d, particularly by adjusting the length, in the axial direction, of the bearing protruding portion 44f.

The sleeve 46 includes a sleeve step portion 46c that an upper edge 44aa of the inner surface 44a of the housing 44 hits or touches. The sleeve step portion 46c is provided radially closer to the rotational axis R than the bearing concave portion 58. The sleeve step portion 46c makes it easier to adjust the coupling position of the sleeve 46 and the housing 44 when coupled together.

The shaft 26 has a shaft step portion 26a that a lower edge 28ca of the inner surface of the hole 28c of the hub 28 hits or touches. If the difference in diameter of the shaft 26 at the shaft step portion 26a is relatively small, the area of the seat 26aa will be relatively small, the seat 26aa being a part where the hub 28 and the shaft 26 faces and touches each other in the axial direction. If the seat 26aa is relatively small, it may become more likely for the shaft to buckle when impact is applied so that the shaft “bites into” the hole of the hub. However, if the difference in diameter at the shaft step portion 26a is made too large, the portion of the shaft 26 that is inserted into the hole 28c becomes relatively thin, and it may become more likely for the shaft to be deformed when impact is applied. To cope with this, the shaft 26 may be formed so that the difference in diameter at the shaft step portion 26a ranges from 0.4 mm to 0.9 mm. In the rotating device 100 shown in FIG. 3, the difference in diameter at the shaft step portion 26a is 0.7 mm. Experiments performed by the present inventors confirmed that this value of the difference could eliminate the buckling or the deformation when impact is applied to the extent where the buckling or the deformation causes problems during real use.

At least the ring portion 30c of the flange 30 is made of material that has a predetermined linear expansion coefficient. The linear expansion coefficient of the ring portion 30c is selected so that, when dimensions of a glue layer 60 and Young's modulus of the glue layer 60 and tensile strength of the glue layer 60 and the linear expansion coefficient of the material of the hub protruding portion 28d are chosen to be parameters, the coupling between the ring portion 30c and the hub protruding portion 28d is maintained under a predetermined test thermal impact.

The tensile stress S applied to the glue layer 60 when a test thermal impact of the temperature difference ΔT is applied is expressed by the following Equation 1. In the Equation 1, the linear expansion coefficient of the hub protruding portion 28d is denoted as α1 and the linear expansion coefficient of the ring portion 30c is denoted as α2; the thickness of the glue layer 60 is denoted as t, Young's modulus of the glue layer 60 is denoted as E, and the radius of the joint surface is denoted as R1.

S=R1×|α1−α2|(ΔT/t)×E (Equation 1)

In the case where S is not beyond the tensile strength σ of the glue layer 60, the coupling can be maintained. Therefore, the linear expansion coefficient α2 of the ring portion 30c is determined so that it satisfies the following Equation 2.

α2<|(σ×t)/(R1×E×ΔT)−α1| (Equation 2)

As a result, the stress applied to the glue layer 60 is suppressed, and it becomes less likely for the coupling to be damaged.

The ring-shaped wall 4e of the base 4 surrounds the hub protruding portion 28d. A gap between the ring-shaped wall 4e and the hub protruding portion 28d forms a labyrinth seal against the lubricant that vaporizes or spreads out from the gas-liquid interface 48a. This labyrinth seal prevents the lubricant that vaporizes or spreads out from leaking radially outward from the labyrinth seal. In the case where the thickness of the rotating device 100 is constant, it is required to make either of the labyrinth seal and the hub, which is situated above the labyrinth seal, shorter in the axial direction when making the other longer in the axial direction. In the rotating device 100 according to this embodiment, the length L5, in the axial direction, of the labyrinth seal is made greater than the thickness L6 of the hub 28, which is above the labyrinth seal. In this case, it becomes easier for the function of the labyrinth seal to be maintained, the function suppressing the leakage of the lubricant 48.

The operation of the rotating device 100 as described above shall be described below. The three-phase driving current is supplied to the coils 42 to rotate the magnetic recording disk 8. Flux is generated along the twelve teeth by making the driving current flow through the coils 42. The flux gives torque to the cylindrical magnet 32, and the rotor 6 and the magnetic recording disk 8, which is fitted to the rotor 6, rotate. Along with this, the voice coil motor 16 swings the swing arm 14, and the read/write head goes back and forth within the swing range on the magnetic recording disk 8. The read/write head converts magnetic data recorded on the magnetic recording disk 8 to an electrical signal and transmits the electrical signal to a control board (not shown). The read/write head also converts data sent from the control board in a form of an electrical signal to magnetic data and writes the magnetic data on the magnetic recording disk 8.

In the rotating device 100 according to this embodiment, the housing 44 is included in the bearing unit 12 and has the first outer surface 44c and the second outer surface 44d. The first outer surface 44c partially overlaps the second outer surface 44d in the axial direction. The first outer surface 44c is attached to the central hole 4h of the base 4. The second outer surface 44d makes contact with the gas-liquid interface 48a of the lubricant 48. As a result, it is possible to make the length, in the axial direction, of the coupling between the bearing unit 12 and the base 4 greater without being largely limited by the length of the capillary seal. This can ensure a sufficient joint strength. Alternatively, it is possible to make the length of the capillary seal greater without being largely limited by the length of coupling. This allows a sufficient amount of the lubricant 48 to be stored, and this can prevent the lubricant 48 from spreading out. In the case where the amount of the lubricant to be stored can be reduced, the gap 56 can be narrowed to correspond to the reduced amount of the lubricant. This can increase the capillary force and, for example, can reduce the leakage of the lubricant when impact is applied. According to these advantages, the impact resistance of the rotating device 100 can be improved, or the rotating device 100 can be thinned while the impact resistance is maintained.

In particular, in the case where the thickness of the rotating device is limited or in the case where the rotating device cannot be made thicker due to requirement of thinning, the rotating device 100 according to this embodiment enables one to set both the length of coupling and the length of the capillary seal, respectively and substantially independent of each other, to be of lengths that take maximum advantage of the thickness of the rotating device 100.

In the rotating device 100 according to this embodiment, the length L2, in the axial direction, of the second outer surface 44d is greater than the length L1, in the axial direction, of the part of the first outer surface 44c that faces the inner surface of the central hole 4h. The length L3, in the axial direction, of a part of the inner surface 30ca of the ring portion 30c that radially faces the second outer surface 44d is greater than the thickness L4 of the base 4 situated below the inner surface 30ca. Since these constraints with regard to dimensions prefer improvement of performance of the capillary seal, these constraints with regard to dimensions are suitable for applications in which it is strongly required for the capillary seal to ensure a sufficient amount of the lubricant or in which it is strongly required to suppress the spread-out of the lubricant.

In the rotating device 100 according to the embodiment, it is not that a concave portion is formed on the upper surface of the base and the bearing protruding portion is inserted into the concave portion, but rather that the base protruding portion 4j is inserted into the bearing concave portion 58. Therefore, the thickness of the base can be maintained as compared to the case where the concave portion is formed on the upper surface of the base and the bearing protruding portion is inserted into the concave portion. As a result, the strength of the base 4 can be maintained while providing the bearing protruding portion 44f. The glue portion between the housing 44 and the base 4 can be made longer by the length of the base protruding portion 4j that protrudes from the upper surface 4d of the base 4. At the same time, the capillary seal can be made longer by the length of the bearing protruding portion 44f.

In the rotating device 100 according to the embodiment, the bearing unit 12 includes the housing 44 and the sleeve 46. Those components are formed separately and then assembled together. The radial dynamic pressure generation grooves 50 are formed on the sleeve 46. The first outer surface 44c and the second outer surface 44d are formed on the housing 44. Therefore, the first outer surface, the second outer surface, and each set of the radial dynamic pressure generation grooves can be manufactured more easily or more precisely as compared to the case where those three elements are formed on a single component. For example, it is less likely for the first outer surface or the second outer surface to be damaged due to chucking when the radial dynamic pressure generation grooves are formed.

In the rotating device 100 according to this embodiment, the housing 44 is glued to the central hole 4h of the base 4. In particular, a part of the first outer surface 44c of the housing 44 that overlaps at least the radial dynamic pressure generation grooves 50 in the axial direction is attached to the central hole 4h via the glue 54. In relation to this, for example, if the whole housing including the part that overlaps the radial dynamic pressure generation grooves is attached to the central hole by interference fit such as press fit, the stress generated by the interference fit may deform the radial dynamic pressure generation grooves. The deformation of the radial dynamic pressure generation grooves may cause unevenness of dynamic pressure and thereby cause unevenness of rotation. To cope with this, in the rotating device 100 according to this embodiment, gluing by loose fit is adopted for the part that overlaps at least the radial dynamic pressure generation grooves 50. As a result, it is less likely for the radial dynamic pressure generation grooves 50 to be deformed by attaching the housing 44 to the base 4.

In the rotating device 100 according to this embodiment, both the first set of thrust dynamic pressure generation grooves 52a and the second set of thrust dynamic pressure generation grooves 52b are formed more radially outward from the rotational axis R than the first outer surface 44c of the housing 44. Therefore, the rotor 6 is axially supported by the dynamic pressure generated at the positions more radially outward from the rotational axis R. As a result, the impact resistance of the rotating device 100 is improved and in particular the rotating device 100 becomes more immune to impact that tends to tilt the rotational axis R. When the thrust dynamic pressure generation grooves are formed, the greater the radius of the grooves is, the easier the grooves are to process.

In the rotating device 100 according to this embodiment, the ring portion 30c and the disk-like portion 30d are formed as a single flange 30. Therefore, the ring portion 30c and the disk-like portion 30d become easier to process and assemble.

In general, the position of the gas-liquid interface 48a of the lubricant 48 may change due to several factors such as ambient temperature, evaporation, gravity, centrifugal force, and variation in the amount of injected lubricant 48. To cope with this, in the rotating device 100 according to this embodiment, the length of the capillary seal is determined in light of these factors so that the gas-liquid interface 48a touches the second outer surface 44d.

Above is an explanation for the structure and operation of the rotating device 100 according to the embodiment. These embodiments are intended to be illustrative only, and it will be obvious to those skilled in the art that various modifications to constituting elements and processes could be developed and that such modifications are also within the scope of the present invention.

The embodiment describes the so-called “outer-rotor type” of the rotating device in which the cylindrical magnet 32 is located outside the laminated core 40. However, the present invention is not limited to this. For example, the present invention may be applied to the so-called “inner-rotor type” of the disk drive device in which the cylindrical magnet is located inside the laminated core.

The embodiment describes the case where the bearing unit 12 is fixed to the base 4, and the shaft 26 rotates with respect to the bearing unit 12. However, the present invention is not limited to this. For example, the present invention may be applied to a shaft-fixed type of the rotating device in which the shaft is fixed to the base, and the bearing unit and the hub rotate together with respect to the shaft.

The embodiment describes the case where the bearing unit 12 is directly mounted onto the base 4. However, the present invention is not limited to this. For example, a brushless motor comprising a rotor, a bearing unit, a laminated core, coils, and a base can separately be manufactured, and the manufactured brushless motor can be installed on a chassis.

The embodiment describes the case where a laminated core is used. However, the present invention is not limited to this. The core does not have to be a laminated core.

The embodiment describes the case where herringbone-shaped grooves are used to generate radial and thrust dynamic pressures. However, the present invention is not limited to this. For example, spiral-shaped grooves may be used or the combinations of herringbone-shaped grooves and spiral-shaped grooves may be used. It is possible to select the shape of the grooves so that the grooves realize the desired characteristic.

What is claimed is:

1. A rotating device, comprising:
a rotor on which a recording disk is to be mounted; and
a stator rotatably supporting the rotor,
wherein the stator includes:
a bearing unit rotatably supporting the rotor by generating dynamic pressure in a lubricant that intervenes between the rotor and the stator; and
a base on which a central hole is formed, the center of the central hole being along a rotational axis of the rotor and the bearing unit being fixed to the central hole,
wherein the bearing unit includes:
a first outer surface joining the central hole; and
a second outer surface formed more radially outward from the rotational axis than the first outer surface, the second outer surface partly overlapping the first outer surface in an axial direction,
wherein a gas-liquid interface of the lubricant exists in a gap between the second outer surface and a facing surface of the rotor that faces the second outer surface.

2. The rotating device according to claim 1, wherein, the closer to the base a portion of the gap between the second outer surface and the facing surface of the rotor is, the greater the width of the portion of the gap becomes.

3. The rotating device according to claim 1, wherein the bearing unit includes:
a cylindrical cylinder portion having the first outer surface; and
a bearing protruding portion protruding axially towards the base, the bearing protruding portion having at least a part of the second outer surface,
wherein the base includes a base protruding portion protruding axially towards the rotor,
the base protruding portion entering in a concave portion formed between the cylinder portion and the bearing protruding portion.

4. The rotating device according to claim 3, wherein the second outer surface surrounds the base protruding portion.

5. The rotating device according to claim 1, wherein the bearing unit includes:
a housing having at least one of the first outer surface and the second outer surface; and
a sleeve formed separately from the housing, the sleeve being fixed in a region more radially inward to the rotational axis than the housing.

6. The rotating device according to claim 5, wherein the sleeve includes a sleeve step portion provided more radially inward to the rotational axis than the first outer surface, an upper edge of an inner surface of the housing touching the sleeve step portion.

7. The rotating device according to claim 1, wherein the bearing unit is formed so that the axial length of the first outer surface is less than the axial length of the second outer surface.

8. The rotating device according to claim 1, wherein radial dynamic pressure generation grooves are formed on either a surface of the rotor or a surface of the stator, the surface of the rotor and the surface of the stator radially facing each other, and wherein a portion of the first outer surface that overlaps the radial dynamic pressure generation grooves in the axial direction is attached to the central hole by glue.

9. The rotating device according to claim 1, wherein thrust dynamic pressure generation grooves are formed on either a surface of the rotor or a surface of the stator, the surface of the rotor and the surface of the stator facing each other in the axial direction and existing in a region more radially outward from the rotational axis than the first outer surface.

10. The rotating device according to claim 1, wherein the rotor includes a hub and a flange formed separately from the hub,
wherein the hub includes a hub protruding portion surrounding the rotational axis of the rotor, the hub protruding portion protruding axially towards the base,
wherein the flange is mounted on an inner surface of the hub protruding portion, and
wherein the flange has a ring portion having the facing surface of the rotor.

11. The rotating device according to claim 10, wherein the cross section of the flange substantially is reverse “L” shape, and
wherein the flange includes a disk-like portion, one end of the disk-like portion being more radially outward from the rotational axis being coupled to the ring portion and at least a part of the other end existing more radially outward from the rotational axis than the first outer surface.

12. A rotating device, comprising:
a rotor; and
a stator rotatably supporting the rotor,
wherein the stator includes:
a bearing unit rotatably supporting the rotor by generating dynamic pressure in a lubricant that intervenes between the rotor and the stator; and
a base on which a central hole is formed, the center of the central hole being along a rotational axis of the rotor and the bearing unit being fixed to the central hole,
wherein the base includes a base protruding portion protruding axially towards the rotor, wherein the bearing unit includes a bearing protruding portion provided more radially outward from the rotational axis than the base protruding portion, the bearing protruding portion protruding axially towards the base,
wherein the bearing unit is mounted to the base so that the base protruding portion overlaps the bearing protruding portion in an axial direction.

13. The rotating device according to claim 12, wherein a gas-liquid interface of the lubricant exists in a gap between an outer surface of the bearing protruding portion and a facing surface of the rotor that faces the outer surface of the bearing protruding portion.

14. The rotating device according to claim 13, wherein, the closer to the base a portion of the gap between the outer surface of the bearing protruding portion and the facing surface is, the greater the width of the portion of the gap will be.

15. The rotating device according to claim 13, wherein the rotor includes a hub and a flange formed separately from the hub,
wherein the hub includes a hub protruding portion surrounding the rotational axis of the rotor, the hub protruding portion protruding axially towards the base,
wherein the flange is mounted on an inner surface of the hub protruding portion, and wherein the flange has a ring portion having the facing surface of the rotor.

16. The rotating device according to claim 15, wherein the cross section of the flange substantially is reverse “L” shape, and
wherein the flange includes a disk-like portion, one end of the disk-like portion, which is more radially outward from the rotational axis, being coupled to the ring portion and at least a part of the other end existing more radially inward to the rotational axis than the bearing protruding portion.

17. The rotating device according to claim 12, wherein the bearing unit includes:
a housing having the bearing protruding portion; and
a sleeve formed separately from the housing, the sleeve being fixed in a region more radially inward to the rotational axis than the housing.

18. The rotating device according to claim 17, wherein the bearing unit includes an outer surface joining the central hole, and
wherein the sleeve includes a sleeve step portion provided more radially inward to the rotational axis than the outer surface of the bearing unit, an upper edge of an inner surface of the housing touching the sleeve step portion.

19. The rotating device according to claim 12, wherein radial dynamic pressure generation grooves are formed on either a surface of the rotor or a surface of the stator, the surface of the rotor and the surface of the stator radially facing each other, and wherein the bearing protruding portion includes a portion that overlaps a part of the radial dynamic pressure generation grooves in the axial direction.

20. The rotating device according to claim 12, wherein thrust dynamic pressure generation grooves are formed on either a surface of the rotor or a surface of the stator, the surface of the rotor and the surface of the stator facing each other in the axial direction and existing in a region more radially inward to the rotational axis than an outer surface of the bearing protruding portion.
